(19) United States
(12) Patent Application Publication
(10) Pub. No.: US 2015/0353189 A1
(43) Pub. Date: Dec. 10, 2015

(54) PROPULSION SYSTEM FOR A HYBRID (CONVERTIBLE) VEHICLE

(71) Applicant: Dmitry Nikolaevich KHARITONOV, Moscow (RU)

(72) Inventor: Dmitry Nikolaevich KHARITONOV, Moscow (RU)

(21) Appl. No.: 14/760,572

(22) PCT Filed: Sep. 2, 2013
(86) PCT No.: PCT/RU2013/000760

§ 371 Date: Jul. 13, 2015

(30) Foreign Application Priority Data
Jan. 15, 2013 (RU) 2013101668

(51) Int. Cl. B64C 25/40; B60F 5/02; B64C 25/34

(52) U.S. Cl. CPC B64C 25/405; B64C 25/34; B60F 5/02

(57) ABSTRACT

The power plant of the hybrid (transformed) vehicle belongs to area of light aircrafts and motorcycles. The essence of the invention is a possibility of transfer the rotary moment from the motorcycle chain not only to the rear wheel, but also to two propellers. Thus propellers together with balancing device, called by the elements of the air drive (EAD) can be fixed in two positions. Firstly when the plane of their rotation is perpendicular to the planes of rotation of a back wheel (the flight mode). Secondly, when propellers (and EAD) are pressed to side parts of the hybrid aircraft (the land mode).

### CROSS-REFERENCE TO RELATED APPLICATION

This application is a National stage application of PCT/RU2013/000760 filed on Sep. 2, 2013 which claims priority to Russian application RU2013101668 filed on Jan. 15, 2013 and currently issued as a patent RU1133470.

### SCOPE OF APPLICATION

Utility model is attributed to the general purpose aviation, namely to gyrocopter. Utility model can be used for construction of hybrid vehicles able to move on ordinary roads like motorcycles, as well as in the air space as gyrocopter. Headings of the International Patent Classification (IPC) of the utility model: B60 F 5/02—transformable air vehicle.

### PRIOR STATE OF ART

According to the state of art, currently most motorcycles use chain (or belt) gear for transfer of the rotary moment from transmission to the rear wheel via the sprocket gear system (see FIG. 1 at site: http//youmotorcycle.com/motorcycle-chain-drive-vs-belt-drive-vs-shaft-drive.html).

It is also known that the rotary moment in gyrocopter is transferred from engine to sustainer screw either directly or via reduction gearbox. While first, sustainer screws of gyrocopters shall have significant diameters in order to ensure thrust force sufficient for takeoff. Second, thrust vector of sustainer screw shall go through the center of mass of the air vehicle or a little bit lower than the center mass in order to avoid gyrocopter unstable behavior in the air. Currently, in order to resolve these issues, gyrocopters usually have small rear wheels on rather high connecting rods; while the distance between wheels is sufficient for operation of one large sustainer screw. Detailed diagram can be seen, for example, in the single-seat gyrocopter of Air Command (see FIG. 2 at site: http://www.aircommand.com/models.php).

Use of high rods with small wheels and, accordingly, high center of gravity are the reason of rather unstable behavior of gyrocopter on the ground. Besides, position of sustainer screw behind the pilot reduces air flow to sustainer screw and therefore results in power loss. Such decision (one large sustainer screw and small wheels on high rods) complicates designing and use of hybrid gyrocopter-motorcycle able to confidently move on the ground and in air space.

Attempts to construct hybrid vehicles able to move on the ground as a motorcycle and in the air as a gyrocopter are known.

For example, American company Butterfly LLC patented flying motorcycle called Super Sky Cycle (see FIG. 3 on site: http://thebutterflyllc.com/sscycle/gallery.htm). Specified structure contains structural decisions standard for gyrocopters (large sustainer screw, small rear wheels and high center of gravity, and no rear shock absorber), which reduces stability of the vehicle while moving on the around.

Sustainer screw in such structure is partially covered by the pilot and engine, which results in power losses.

Dutch company PAL-V also develops structure of flying motorcycle. In order to keep vehicle stability in the air without deteriorating its stability on the ground, Dutch designers used rather sophisticated technologies. First, this is folding sustainer screw. Second, technology that allows making vehicle housing leaning in the direction of the turning circle radius when moving on the ground (see FIG. 4 at the site: http://www.pal-v.com).

Decisions taken by PAL-V designers for development of hybrid vehicle are complicated, expensive and not complete. Specified decisions allow ensuring satisfactory stability of the vehicle when moving on the ground; however, they are expensive; and the issue of power losses due insufficient air intake to sustainer screw is not resolved.

### DISCLOSURE OF INVENTION

Objective of development of the utility model was designing of the device (parts of propulsion plant) that allows the best combination of the vehicle stable movement on the ground (when rotor is removed and fixed at the vehicle sides) and in the air with minimum cost and time expenses. Utility model application will result in construction of the mobile re-arranged propulsion plant that allows convert motorcycle drive into the flying vehicle drive and vice versa, as well as implement stable movement of the vehicle on the ground and in the air.

The following changes are to be incorporated into the motorcycle drive structure in order to resolve the set objective.

Sprocket gear (hereinafter—sustainer screw sprocket gear) shall be installed on the shaft that goes through the rear wheel axis. Sprocket gear size, number of teeth shall be selected so that rotation frequency corresponds to the sustainer screw in-flight rotation frequency. One bearing is built-in in both jaw branches, on which the rear wheel is fixed by means of the mentioned shaft. The rear wheel shaft now goes through three bearings: two on the jaw ends at both sides of the rear wheel, and one inside the wheel.

If propulsion plant switching into the flying mode is required, chain (or belt) switching from one sprocket gear (located at the outer side of the rear wheel bearing) to the other sprocket gear (located at the rear wheel shaft) is occurred. Air-operated components (AOC) are fixed on both sides of the rear wheel to the jaw branches (through hinged joint) and to bearings installed at the jaw ends. AOC is a super-frame, inside which sustainer screw is located.

AOC consists of:
AOC rod with hinged joint with the rear wheel jaw branch;
sleeve of the trim landing gears rack, from which the trim landing gears rack can be protracted and fixed;
sleeve of sustainer screw shaft, inside which sustainer screw shaft is fixed on the bearing (sustainer screw shaft can be connected with the rear wheel shaft via the drive shaft);
angle gearbox (CVUJ or drive, shaft can be also used) that is connected with sustainer screw shaft and the sustainer screw;
sustainer screw that is connected with the angle gearbox;
semi-rod of AOC, one end of which is fixed to the angle gearbox housing, while the other end is fixed to the sleeve of trim landing gear rack.

When sleeve of sustainer screw shaft is fixed to the outer side of the jaw bearing, sustainer screw shaft is connected with the rear wheel shaft via small drive shaft. Diameter of the rear wheel has to be larger than the diameter of sustainer screws for ensuring free rotation of sustainer screws. Therefore, chain (or belt) movement creates rotation of two sustainer screws fixed at both sides of the rear wheel in the plain perpendicular to it, rather than rotation of the rear wheel. Rotation of sustainer screws is done in reverse directions thanks to angle gearboxes.

Diameter of both sustainer screws will be less than the diameter of one sustainer screw that would be required for ensuring flying of the vehicle of the same weight. It means the vehicle center of gravity can be lowered by the value of reduction of the sustainer screw radius. Therefore, the vehicle will be more stable of the similar vehicles, while stability during flying mode will be increased.

When vehicle moves on the ground without any intention to fly, sustainer screw shaft is removed from the rear wheel axis and retracted being pushed to the motorcycle sides. AOC can be also totally removed. Rotor is removed from support during the ground movement and can be fixed along the vehicle sides.

Vehicle constructed with the use of such utility model has higher rear wheel that the standard motorcycle; however, propulsion plant of the vehicle allows performing switching from the ground mode to the flying mode and vice versa. When moving on the ground in the motorcycle mode (when rotor of gyrocopter is removed), such vehicle will be more stable than the similar vehicles (PAL-V and SuperSkyCycle), as it has stable scheme of standard motorcycle. When flying in the air, the vehicle will be more stable than both PAL-V, SuperSkyCycle and even standard gyrocopter by means of two sustainer screws rotating in reverse directions reactive torques at sharp speed release or sharp acceleration are absent; vehicle nose turning is more difficult to do by means of the opposite air flow when two running sustainer screws are available).

### BRIEF DESCRIPTION OF DRAWINGS

Five figures are attached to the invention description, which demonstrates significant features of utility model.

FIG. 5 demonstrates changes that have to be incorporated in the structure of the motorcycle rear wheel. Air-operated component (AOC) is not shown on FIG. 5 for convenience of description.

FIG. 6 demonstrates one of modifications (rectangular) of the structure of detachable AOC.

FIG. 7 demonstrates other modification (triangular) of the structure of detachable AOC.

FIG. 8 demonstrates gear of hybrid vehicle in flying mode (with attached rectangular AOC).

FIG. 9 demonstrates isometric perspective of the hybrid vehicle gear in flying mode (with attached triangular AOC).

### OPTIONS OF EMBODIMENT OF INVENTION

Propulsion plant of hybrid (transformable) vehicle can be implemented in the following way.

Calculations demonstrate approximate ratios of the flying weight, thrust force and engine power (see table 1, information is taken at the site www.prostor.webzone.ru).

TABLE 1

| | | Examples of | Gyrocopter |
|---|---|---|---|
| | Power | actually reached | flying |
| Engine | (h.p.) | static thrust (kgf) | weight (kg) |
| Hirth33 | 22 | 70 | 140 |
| RMZ 640 Buran | 35 | 110 | 220 |
| RMZ 500 Taiga | 45 | 140 | 280 |
| Rotax 582 | 64 | 160 | 320 |
| Rotax 912 | 80 | 200 | 400 |
| Rotax 912 ULS | 100 | 230 | 460 |
| Subaru EJ 25 | 150 | 280 | 560 |
| Strbaru EZ 30 | 200 | 390 | 780 |
| SubaruEJ205 turbo | 220 | 430 | 860 |

It is known that the weight of light models of motorcycles (dirt off-highway motorcycles) with the engine power of 70 h.p. sufficient for flying of gyrocopter with flying weight 350 kg) amounts to 100 kg. In order to calculate the weight of the single-seat hybrid vehicle, specified weight of motorcycle shall be summarized with the rotor weight (about 17 kg), weight of two sustainer screws with trim landing gears (about 20 kg), increase of the weight of rear wheel and jaw (about 15 kg), weight of fin assembly (about 10 kg) and the weight of rotor support (about 10 kg). Total weight of the single-seat hybrid vehicle (motor-cycle) shall not exceed 200 ka.

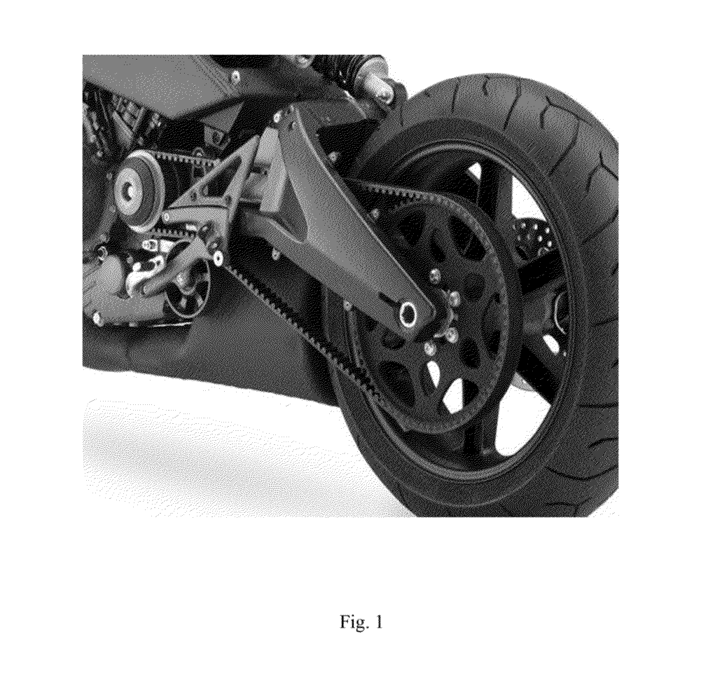

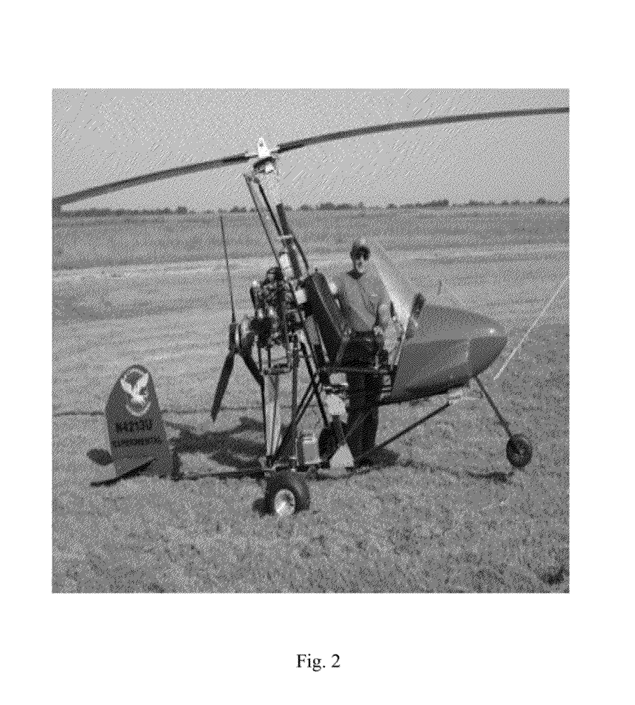

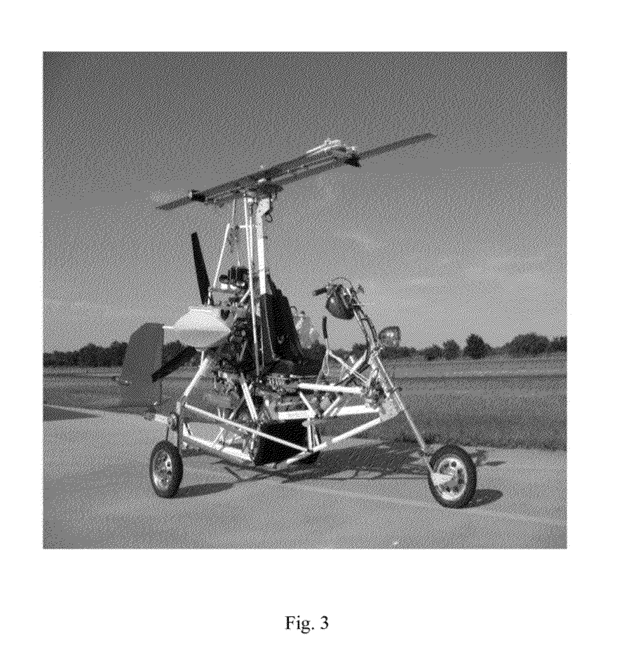

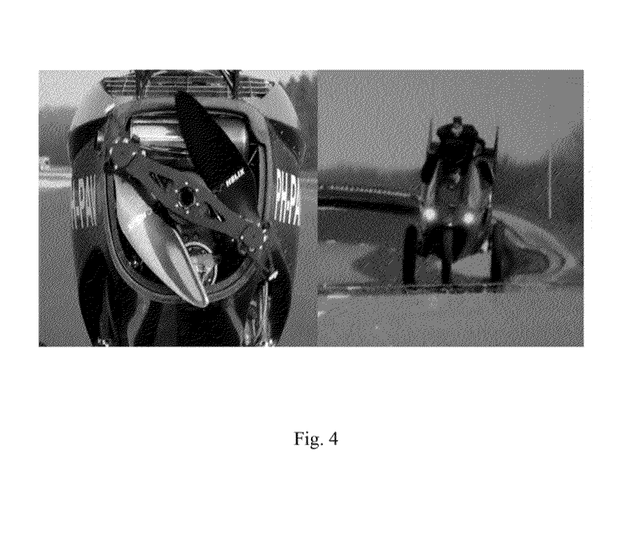

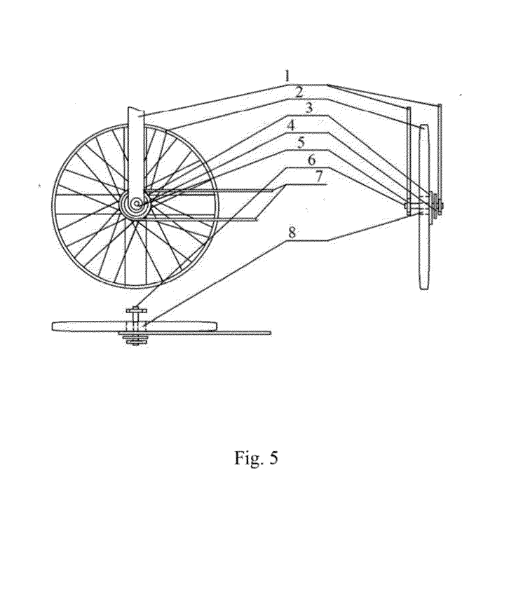

The vehicle includes (see FIG. 5):

Steel jaw of rear wheel with long branches (about 0.7 m). Jaw enfolds rear wheel with its branches on both sides. Steel shaft of rear wheel goes through the ends of each branch of the jaw and through the rear wheel axis.

Rear wheel of large diameter (about 1.1 meter) is made of light alloy. Rear wheel is attached to the jaw with steel rear wheel shaft and three bearings. One bearing is installed on the rear wheel axis; two other bearings are built-in in the ends of each jaw branch.

Rear wheel sprocket gear that is rigidly installed on the outer side of the rear wheel bearing. Rear wheel gets rotary moment from the chain or belt going from transmission via such sprocket gear.

Sustainer screw sprocket gear that is also rigidly installed on the rear wheel shaft. When chains is moved from the rear wheel sprocket gear to the sustainer screw sprocket gear, rotary moment is transferred to sustainer screws via the system of connected components: rear wheel shaft—drive shaft—sustainer screw shaft—angle gearbox.

Bearings of rear wheel jaw. They allow free movement of rear wheel shaft, therefore transfer rotation from sustainer screw sprocket gear to sustainer screws through the above system: rear wheel shaft—drive shaft—sustainer screw shaft angle gearbox.

Steel shaft of cylindrical rear wheel. Rear wheel shaft has rectangular slots at the ends that allow attach small steel drive shafts to them (that have appropriate overhangs) connected with the sustainer screws shafts.

Steel chain (or belt) transferring rotation from transmission to any sprocket gear. When moving on the ground, chain transfers rotation to the sprocket gear of rear wheel. When flying, chain transfers rotation to the sprocket gear of sustainer screws in ‘takeoff’ and ‘landing’ modes. Transfer of chain from one sprocket gear to the other can be done by means of switch implemented on racing bicycle (switch is not shown on attached figures).

Bearing of rear wheel that is installed in the rear wheel axis.

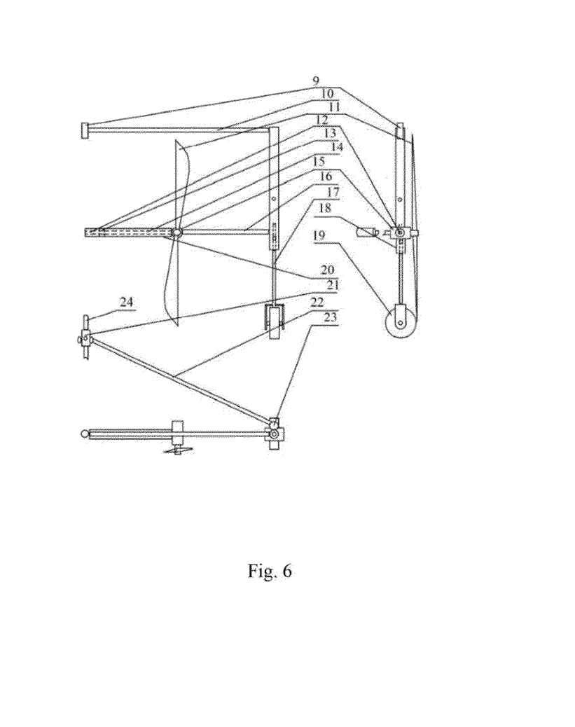

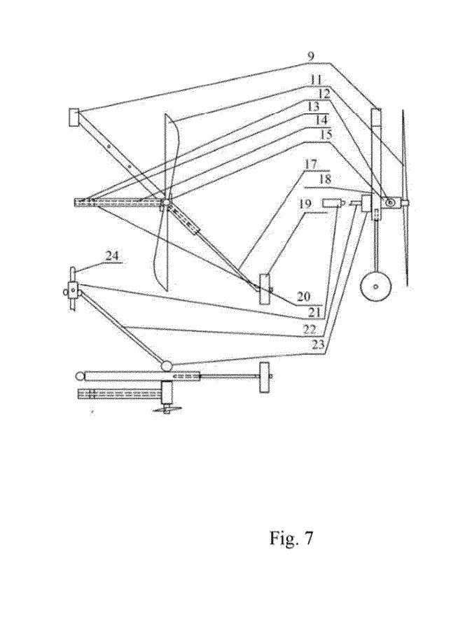

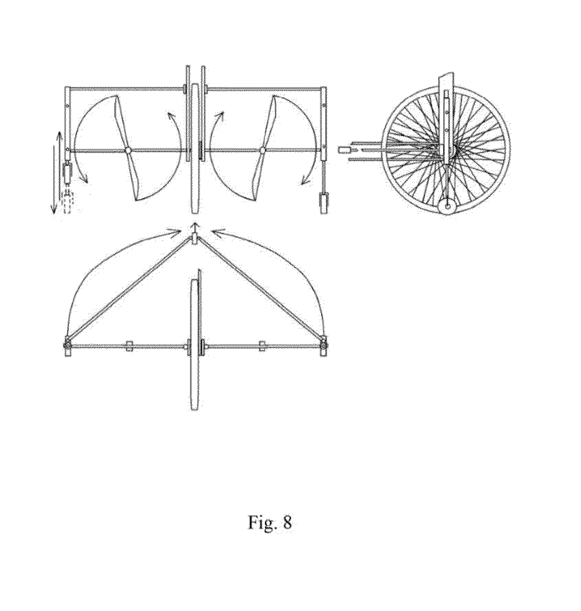

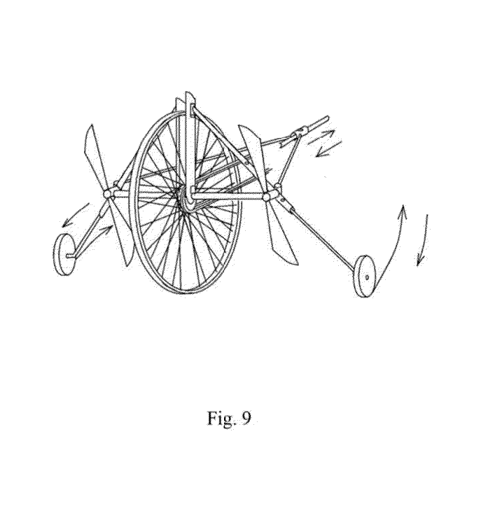

The system of parts called the air-operated component (AOC) in the present description is attached to each branch of the rear wheel jaw (that can be rigidly fixed). AOC is made in two modifications (FIG. 6 and FIG. 7). AOC modifications differ in geometry; however, their essence is the same—they contain power components (sustainer screws) and trim landing gears for vehicle balancing, in ‘takeoff’ and ‘landing’ modes. Therefore AOC description presented on FIG. 7 (best option of the utility model implementation) is similar to description of AOC presented on FIG. 6, except for absence of dimension rods and semi-rods of AOC; and sleeves of trim landing gear racks are fixed directly to the top AOC fixation and the angle gearbox housing end-faces in case of FIG. 7.

AOC top fixation. It is steel hinged loop that allows rigid fastening of AOC to the branch of rear wheel jaw in its top part.

Steel dimension rod of AOC. AOC rod is a component of trim landing gear fastening. AOC rod holds sleeve with retractable trim landing gear rack at the distance sufficient for sustainer screw rotation (exceeding diameter of sustainer screw).

Sustainer screws. They are made of wood or composite materials. Sustainer screw diameter for single-seat hybrid vehicle amounts to about 0.9 meter. Sustainer screws are fixed to angle gearboxes transferring rotation to them.

Small steel drive shaft is rigidly fixed with one end to the sustainer screw shaft. The other end of sustainer screw is furnished with rectangular overhang, that allows connection with the rear wheel shaft (that has rectangular slots at the ends). Thus, rotary moment is freely transferred from the rear wheel shaft to the sustainer screw shaft even when axes of both shafts are located at an angle to each other.

Bearing of sustainer screw shaft is installed inside the sleeve of sustainer screw shaft and connects sleeve and shaft of sustainer screw allowing free rotation of sustainer screw shaft.

Steel shaft of sustainer screw. Sustainer screw shaft is simple cylinder and allows transferring rotation from the rear wheel shaft to the angle gearbox that transfers rotation to sustainer screw. Sustainer screw shaft is fixed with sustainer screw shaft bearing on the one end, and with the angle gearbox on the other end.

Steel angle gearbox. It is rigidly fixed to the sleeve of sustainer screw shaft with one end, and to the AOC semi-rod with the other end. Thus, position of angle gearbox (and sustainer screw connected with it) is rigidly fixed at the AOC center. Sustainer screw shaft is rigidly connected with one of conic gears inside the angle gearbox, while the other conic gear is rigidly connected with the sustainer screw axis. That is how sustainer screw shafts rotation is transferred to sustainer screws.

Steel dimension cylindrical semi-rods are rigidly fixed with their one ends on the housings of angle gearboxes. Other ends of semi-rods are rigidly fixed with sleeves of trim landing gears. Semi-rods allow rigid fixing of the sustainer screw axis position in the center of AOC.

Steel rack of trim landing gears. Rack has cylindrical shape. Trim landing gears are fixed on it. Rack can be retracted into the sleeve and can be rigidly fixed in both retracted and protracted positions by means of holes in the rack and sleeve and small steel pins or screws and nuts.

Steel sleeve of trim landing gears rack. It has the shape of hollow cylinder with holes for fixing rack of the trim landing gears. Trim landing gears rack can be located inside the sleeve, when trim landing gears are retracted for vehicle operation in the ground mode. AOC rod and semi-rod are rigidly fixed on the sleeve of trim landing gears rack.

Trim landing gears. They serve for vehicle balancing in the ‘takeoff’ and ‘landing’ modes. They prevent contact of sustainer screws with the ground surface. Wheels of small garden barrow for soil transportation can be used as trim landing gears. They do not take up the loads of vehicle, but serve for vehicle balancing in the above modes.

Steel sleeve of sustainer screw shaft. It is steel tube of round section. One of the ends is connected to the branch of rear wheel jaw by means of hinged joint allowing rigid fixing (not shone on the figures). Sustainer screw shaft is fixed inside the said sleeve by means of bearing, which transfers rotation from the wheel shaft to the angle gearbox. The other end of sustainer screw shaft sleeve is fixed to the angle gearbox.

Steel sliding joint. It is a tube of round or rectangular section (depending on the motorcycle frame section). Tube is put on the motorcycle frame and can be moved along the frame and foxed in two positions on the frame (in the position when AOC is installed along the motorcycle side for the ground mode movement and in the position when sustainer screws of AOC are installed in the plain perpendicular to the rear wheel plain). Fixing can be done by means of installation of small pin in the holes on sliding joint and motorcycle frame. Sliding joint is connected with the frame rod by means of small steel ball-and-socket hinge.

Steel frame rod can be of any section; however, should be sufficiently strong. It serves for fixing AOC in two positions: the flying one, when sustainer screws are located in the plain perpendicular to the rear wheel plain, and the ground one, when AOC and sustainer screws are located along the vehicle housing. One end of the frame rod is connected with sliding joint, the other end—with the hinged joint on the landing gear rack sleeve.

Steel hinged joint on the landing gear rack sleeve connects frame rod and landing gear rack sleeve.

Steel frame of the vehicle is one of the vehicle backbone components. Sliding joint is installed on the frame that can be fixed in two positions for AOC installation in the ground and flying modes.

When vehicle is operated in the ground mode, chain (7) is put by means of switch on the sprocket gear (3) of rear wheel. Rotary moment is transferred from transmission via chain and sprocket gear of rear wheel to the rear wheel. Sliding joint (21) is moved along the motorcycle frame and is installed in the extreme position (maximum proximity to front wheel) and is fixed in this position on the frame. AOC and sustainer screws take position along the motorcycle sides. Trim landing gears racks (17) are retracted in sleeves (18) and fixed. Vehicle propulsion plant is ready to move in the motorcycle ground mode. Large rear wheel (2) at lowered center of gravity (lowering is done by decreasing diameter of sustainer screws (11)) provides for vehicle stable position in the motorcycle mode.

When vehicle is operated in the gyrocopter mode, chain (7) is set by means of switch on sprocket gear (4) of sustainer screw. Sliding joint (21) is moved along the motorcycle frame and is set in the extreme position (maximum proximity to rear wheel) and is fixed in this position. AOC and sustainer screws take position perpendicular to the rear wheel. Drive shaft ends (12) are inserted in slots of the rear wheel shaft (6). Trim landing gear racks (17) are protracted from sleeves (18) and fixed. Rotary moment is transferred from transmission via chain (7), sprocket gear of sustainer screw (4), rear wheel shaft (6), sustainer screw shafts (14) and angle gearboxes (15) to sustainer screws (11). Propulsion plant is ready to move in the gyrocopter flying mode. As angle gearboxes (15) are located in opposite directions, rotation of sustainer screws (11) is done in reverse directions. This allows compensating reactive torques of sustainer screws at either sharp increase of engine revolutions or their reduction. Therefore, vehicle in such situations is not turned around in the air in the directions transversal to movement. Low location of thrust vectors of sustainer screws (by means of reduced diameter of each of both sustainer screws (11) in comparison when one large sustainer screw is used) ensures pitching stability of vehicle when flying—vehicle is not swung up and down relative its center of gravity.

### INDUSTRIAL APPLICATION

The device serves for construction of hybrid vehicles able to move on the ground as a motorcycle (with rotor removed and fixed at the sides), as well as in the air as a gyrocopter. Hybrid vehicles can be used by people, agencies, and public authorities for fulfillment of different tasks: personal and company transport, tourism, monitoring, patrolling, first aid, etc.

What is claimed is:

1. A propulsion plant of a hybrid vehicle, comprising:
a large rear wheel, and
two sustainer screws set-out and fixed in planes perpendicular to the rear wheel connected by means of a set of components, including angle gearboxes or CVUJ (constant-velocity universal joints), shafts, drive shafts with a shaft going through a rear wheel axis, on which a sprocket gear is placed, on which a motorcycle chain or a belt moves that transfers rotation from a transmission to such sprocket gear; while a bearing is installed on the rear wheel axis as well as on two branches of a rear wheel jaw, so that the rear wheel shaft is fixed among three bearings.

2. The propulsion plant of claim 1, further comprising: a sleeve, from which a gear leg is protracted and fixed, being connected by means of a rod and a semi-rod that together with the sleeve arrange a rectangular super-frame around each sustainer screw; while fastening of trim landing gears prevent contact of the sustainer screws with the ground in the ‘takeoff’ and ‘landing’ modes.

3. The propulsion plant of claim 1, further comprising: sleeves, from which racks of trim landing gears are protracted and fixed, are connected with one end-face with an appropriate rear wheel jaw branch by means of a hinged joint, while another end is connected with an end-face of an appropriate sustainer screw angle gearbox, so that, geometrically, the sleeve, the jaw branch and the sustainer screw shaft arrange a kind of triangle ensuring better stability against misalignment of the trim landing gear in the ‘takeoff’ and ‘landing’ modes
